(19) United States
(12) Patent Application Publication
(10) Pub. No.: US 2010/0191881 A1
(43) Pub. Date: Jul. 29, 2010

(54) System and Method for Reserving and Provisioning IT Resources

(75) Inventors: Marcin P. Tauter, Oyster Bay, NY (US); Christine Teresa Munson, Long Island City, NY (US); Lin Shi, Lake Grove, NY (US); Bin Zhao, Toronto (CA); Peter A. Cryer, Mississauga (CA); George D. Watt, Kanata (CA); Vasken Torossian, Round Rock, TX (US)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 12/358,437

(22) Filed: Jan. 23, 2009

(51) Int. Cl. G06F 13/00

(52) U.S. Cl. 710/104

(57) ABSTRACT

A method for reserving and provisioning IT resources comprises receiving, from a user, a request to reserve a desired configuration of IT resources. The desired configuration comprises one or more desired technical specifications and a desired reservation time having a start time and an end time. The method further comprises accessing an IT resource database to determine one or more of a plurality of resource pools that the user has access to. The one or more resource pools are consulted to determine if one or more IT resources matching the desired configuration are available. If the one or more IT resources matching the desired configuration are available, the one or more IT resources are reserved for the user and provided to the user at the start time.

### TECHNICAL FIELD

The present disclosure relates generally to IT resource management, and more specifically to a system and method for reserving and provisioning IT resources.

### BACKGROUND

As technology advances, it is increasingly desirable to have access to a multitude of information technology (IT) resources. These resources may be used in the development of new software, technology support, and sales demonstrations. IT resources may include various operating systems, software, hardware, and/or combinations thereof. However, due to the cost of these resources, it may be difficult for a single user or group of users to have access to a large selection of IT resources. Therefore, organizations may find it helpful to share IT resources among various groups or entire enterprises.

### SUMMARY OF EXAMPLE EMBODIMENTS

The present disclosure is directed to a system and method for reserving and provisioning IT resources. The teachings of the present disclosure may allow for automated reservation and more efficient allocation of IT resources.

In accordance with a particular embodiment of the present disclosure, a method comprises receiving, from a user, a request to reserve a desired configuration of IT resources. The desired configuration comprises one or more desired technical specifications and a desired reservation time, having a start time and an end time. The method further comprises accessing an IT resource database to determine one or more of a plurality of resource pools that the user has access to. The one or more resource pools are consulted to determine if one or more IT resources matching the desired configuration are available. If one or more IT resources matching the desired configuration are available, the one or more IT resources are reserved for the user and the desired configuration is provided to the user at the start time. According to more particular embodiments, if one or more IT resources are not available at the desired reservation time, an alternative time is suggested to the user for reservation.

In accordance with another aspect of the present invention, a system comprises a graphical user interface that is operable to receive, from a user, a request to reserve a desired configuration of IT resources. The desired configuration comprises one or more desired technical specifications and a desired reservation time, having a start time and an end time. The system further comprises a processor and an IT resource database that is operable to store IT resources. The processor is operable to access the IT resource database and determine one or more of a plurality of resource pools that the user has access to. The processor is further operable to consult the one or more resource pools to determine if one or more IT resources matching the desired configuration are available. If one or more IT resources matching the desired configuration are available, the processor is further operable to reserve the one or more IT resources and provide the desired configuration of IT resources to the user at the start time.

In accordance with another aspect of the present invention, logic encoded in a tangible computer readable medium is operable, when executed on a processor, to receive, from a user, a request to reserve a desired configuration of IT resources. The desired configuration comprises one or more desired technical specifications and a desired reservation time, having a start time and an end time. The logic is further operable to access an IT resource database to determine one or more of a plurality of resource pools that the user has access to. The logic may then consult the one or more resource pools to determine if one or more IT resources matching the desired configuration are available. If the one or more IT resources matching the desired configuration are available, the processor is further operable to reserve the one or more IT resources and provide the desired configuration of IT resources to the user at the start time.

Technical advantages of particular embodiments of the present disclosure include a method for receiving requests from a user to reserve a desired configuration of IT resources. This may allow scheduling of IT resources for more efficient resource management. Additionally, this method may allow for sharing of resources among different groups, providing more efficient management of the peaks and valleys of development cycles.

Further technical advantages of particular embodiments include providing a desired configuration of IT resources to a user at a reserved time. This may allow a user to access resources that are physically located in separate labs. This may provide more cost efficient management of resources across an organization.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 is a schematic drawing illustrating a computer network configuration suitable for use within particular embodiments of the present disclosure; and

FIG. 2 is a flow diagram illustrating a method for reserving and provisioning IT resources.

### DETAILED DESCRIPTION

It is often desirable to have access to a multitude of different IT resources. This access may be used by software developers in the development and testing of various different software applications. Sales representatives may also desire such access in order to demonstrate various software applications using a single machine. Additionally, technology support representatives may desire such access in order to recreate the work environments of various users on their own computer, facilitating easier problem diagnosis. However, due to financial and space constraints, it may be difficult for a single user or group of users to have access to a large selection of IT resources. Therefore, organizations often find it helpful to pool IT resources and provision them among various groups or an entire enterprise.

In accordance with the teaching of the present disclosure, a system and method for reserving and provisioning IT resources is provided. An object of the present disclosure is to provide more efficient management of IT resources.

According to particular embodiments of the present disclosure, a method comprises receiving, from a user, a request to reserve a desired configuration of IT resources. The desired configuration comprises one or more desired technical specifications and a desired reservation time, having a start time and an end time. The method further comprises accessing an IT resource database to determine one or more of a plurality of resource pools that the user has access to. The one or more resource pools are consulted to determine if one or more IT resources matching the desired configuration are available. If one or more IT resources matching the desired configuration are available, the one or more IT resources are reserved for the user and the desired configuration is provided to the user at the start time. According to more particular embodiments, if one or more IT resources are not available at the desired reservation time, an alternative time is suggested to the user for reservation.

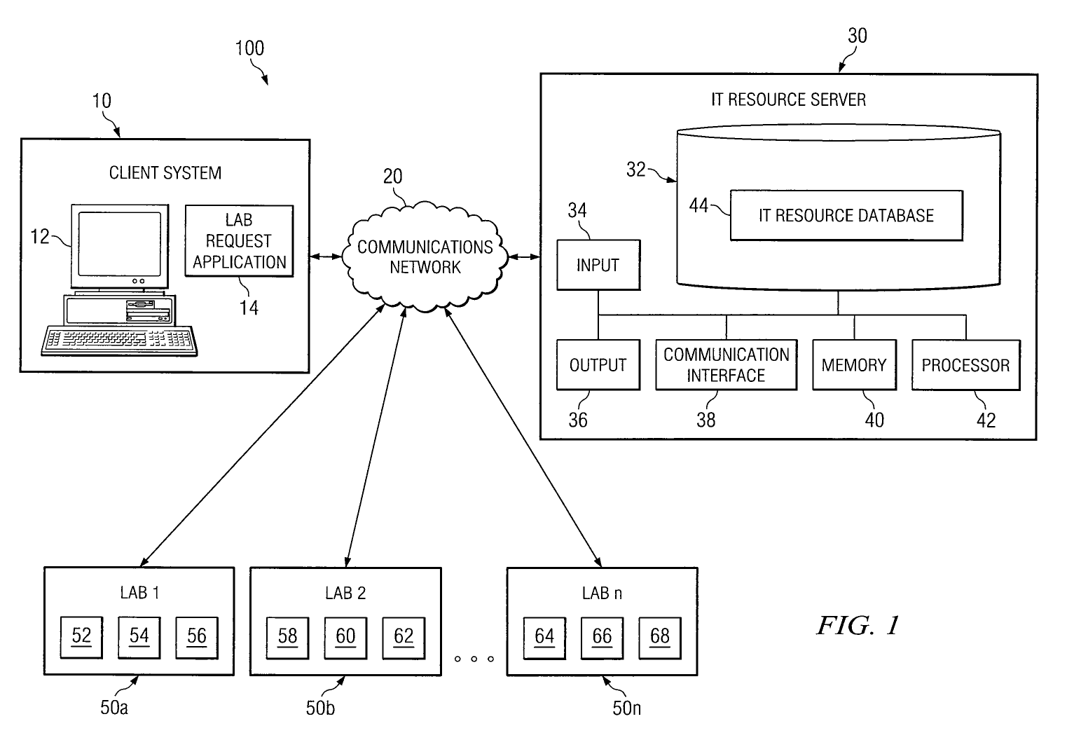

FIG. 1 illustrates a communications system, generally designated by reference numeral 100. Communications system 100 includes client system 10, communications network 20, IT resource server 30, and a plurality of labs 50.

Client system 10 includes a computer terminal 12, or other medium for accomplishing electronic communication. Terminal 12 may also include specific software, including a lab request application 14, which allows standardized communication with IT resource server 30. According to particular embodiments, lab request application 14 may be web-based, allowing communication with IT resource server 30 via a webpage. Lab request application 14 may also make use of an application programming interface (API) and/or Web Services to provide more interoperability across a network. In particular embodiments, a specialized installer may allow any user to download and install a resource server and programs to run lab request application 14 on virtually any machine. Although the illustrated embodiment depicts client system 10 as a separate element, in alternative embodiments client system 10 may reside locally on server 30 or at one of the various labs 50.

IT resource server 30 may refer to any device that is operable to deliver information or IT resources that are sent to the client system 10. According to the illustrated embodiment, server 30 includes storage device 32, an input device 34, an output device 36, a communication interface 38, a memory device 40, and a processor 42.

Input device 34 may refer to any suitable device that is operable to input, select, and/or manipulate various data and information. Input device 34 may include, for example, a keyboard, mouse, graphics tablet, joystick, light pen, microphone, scanner, or other suitable input device.

Output device 36 may refer to any suitable device that is operable for displaying information to a user. Output device 36 may include, for example, a video display, a printer, a plotter, or other suitable output device.

Communication interface 38 may refer to any suitable device that is operable to receive input for server 30, send output from server 30, perform suitable processing of the input or output or both, communicate to other devices, or any combination of the preceding. Communication interface 38 may include appropriate hardware (e.g. modem, network interface card, etc.) and software, including protocol conversion and data processing capabilities, to communicate through a LAN, WAN, or other communication system that allows server 30 to communicate to other devices. Communication interface 38 may include one or more ports, conversion software, or both.

Memory device 40 may refer to any suitable device operable to store and facilitate retrieval of data, and may comprise random access memory (RAM), read only memory (ROM), a magnetic drive, a digital video disk (DVD) drive, removable media storage, any other suitable data storage medium, or a combination of any of the preceding.

Processor 42 may refer to any suitable device operable to execute instructions and manipulate data to perform operations for server 30. Processor 42 may include, for example, any type of central processing unit (CPU).

Storage device 32 may refer to any suitable device operable for storing data and instructions. Storage device 32 may include, for example, a magnetic disk, flash memory, optical disk, or other suitable data storage device. According to the illustrated embodiment, storage device 32 may comprise IT resource database 44.

IT resource database 44 may be any database or other suitable storage device capable of storing information regarding IT resources that are available in various labs 50 located throughout communication system 100. According to particular embodiments, this information may include, but is not limited to technical specifications, times of availability, times of reservation, and current status (i.e. available or leased out) for each of the IT resources. This information may further include relationship and compatibility information between the various IT resources.

Labs 50 may refer to physical or virtual lab environments comprising various IT resources. These resources may include, but are not limited to operating systems, physical systems, software virtualized systems, hardware virtualized systems, and/or any combination thereof. Virtualization may allow the partitioning of one physical machine or server into multiple virtual machines, enabling various IT resources to be shared and more efficiently used across a network. In the illustrated embodiment, multiple labs are displayed: lab 1 designated by reference number 50 a, lab 2 designated by reference number 50b, and so on until lab n designated by reference number 50n. Traditionally, each of these labs would have its own administrator in charge of the lab's resources. Often there was little communication between the labs, and any sharing of IT resources required manual intervention and coordination by the various lab administrators. According to the present disclosure, IT resource database 44 may provide a lease administrator in order to provide automated central lease management.

Each of the labs illustrated in FIG. 1 comprise a plurality of resource pools. As used throughout this disclosure, “each” means every one of at least a subset of the identified items. For instance, Lab 1 contains resource pools 52, 54, and 56, Lab 2 contains resource pools 58, 60, and 62, and Lab n contains resource pools 64, 66, and 68. Resource pools refer to a grouping of any type of IT resource. The IT resources may be grouped according to any criteria, including but not limited to type of operating system, type of software, type of hardware, geographic location, or virtually any other means of organization that a user may select.

According to particular embodiments, each pool may have a particular user or group that is designated as an “owner” of the resource pool. This may be because that owner physically possesses the IT resources stored in the pool. In particular embodiments, owners may possess a particular need for prioritized access to the resources in the pool. At a minimum, ownership of a resource pool grants that owner access to the IT resources contained therein. According to particular embodiments, an owner may also have the power to grant access or membership in the pool to other users. The owner may also create and/or modify policy sets governing the resource pools. Policy sets may specify particular policies or rules related to the pool. According to particular embodiments, policy sets may define which users may access the pool, which users get priority access, and the length of time for which resources may be leased from the pool.

Although the illustrated embodiment depicts multiple labs and pools, in alternative embodiments, any number of labs and/or pools may be used to store IT resources, including only a single lab or pool. Also, in the illustrated embodiment, each of the labs are located separately throughout communication system 100. In alternative embodiments, one or more labs 50 could be located on client system 10 or on IT resource server 30.

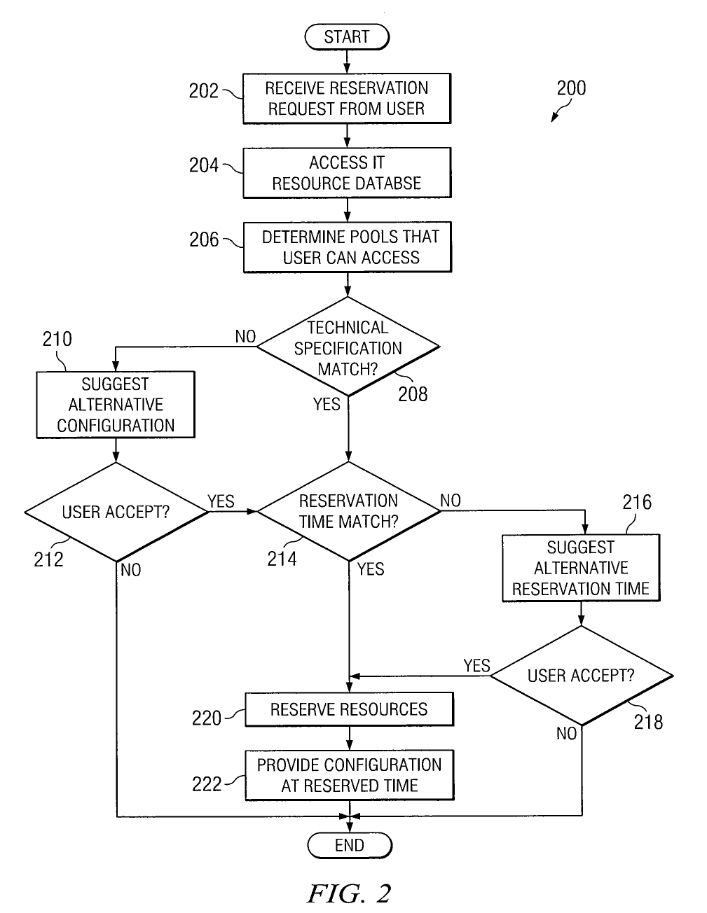

FIG. 2 illustrates a flow diagram showing a method for reserving and provisioning IT resources. As used herein, the phrase “provisioning” may mean managing and making IT resources available to various users. It may also be used interchangeably with the term “leasing.” The steps of FIG. 2 will be described in detail below, making reference to specific elements of FIG. 1.

The process begins at step 202, where a reservation request is received from a user. As stated before, a user may be any person who desires access to various IT resources. The list of users may include, but is not limited to software developers, technical support personnel, and sales representatives. Multiple users may have access to IT resource database 44. These users may share a single client system 10 or may access the database 44 using multiple different client systems and computer terminals. In particular embodiments, an installer feature may allow users to automatically download and install a resource server and programs to run lab request application 14 on virtually any machine.

Access to IT resource database 44 using lab request application 14 may vary depending on the user. According to particular embodiments, each user may have a unique user ID that coincides with the access rights of that particular user. Depending on their role within the organization, certain users may have access to more IT resources than other users. This may depend on access to and/or ownership of particular resource pools. As discussed above, the owner of a particular pool may have access to the resources located therein. Additionally, a user may be granted access to a private pool by the owner of that pool. Finally, some resources may be in public pools that are available to any user. According to particular embodiments, certain users, such as owners, may even receive priority access to certain IT resources over other users.

According to particular embodiments, lab reservation application 14 may operate programmatically using Web Services. This may allow more interoperability between different machines on a network. According to particular embodiments, Web Services may be employed using an API. According to alternative embodiments, lab reservation application 14 may be web-based, allowing the user to make requests using a webpage interface on computer station 12. This may be any sort of web interface that allows a user to request IT resources. According to particular embodiments, this may be accomplished using a form interface. For example, the form may comprise pull-down menus for the various request categories entered by the user, including but not limited to operating system platform, other software, hardware, and reservation times.

According to particular embodiments, this may be an iterative process, as particular categories may be dependent upon other categories selected. For instance, certain types of software or hardware may only be available with a particular operating system platform. As such, these types of software and/or hardware may not be shown until the relevant operating system is selected by the user. According to alternative embodiments, instead of using pull-down menus, the user may be able to type in request categories, and lab request application 14 will check IT resource database 44 to determine if there are any resources matching the request entered. Additionally, the information presented may depend on the user's access to the plurality of resource pools. According to particular embodiments, the user may only be able to see available IT resources located on the pools to which the user has access. In alternative embodiments, a user may be able to see all available IT resources, including those located in resource pools to which the user does not have access. In these embodiments, the resources that cannot be accessed may be designated as blocked for the particular user. Although specific interfaces have been described, virtually any user interface may be employed in accordance with the present disclosure for a user to submit a resource request.

As part of the IT resource request, the user may also request the resources at a desired reservation time. This may be a request for immediate access, allowing the user to submit an “on-demand” request. Alternatively, the resources may be requested for some specified time in the future. According to particular embodiments, the user's request may include both a desired start time and a desired stop time for the reservation or lease. According to alternative embodiments, the user may only submit a desired start time. According to these embodiments, the reservation may have a standard duration, thereby automatically setting the lease end time. According to particular embodiments, this information may be defined in the policy set for the relevant resource pool. Alternatively, this may result in an open-ended reservation of resources, wherein the user obtains access to the resources indefinitely. However, the duration of such an open-ended reservation may be defined in a policy set for the given pool.

At step 204, lab request application 14 accesses IT resource database 44. As described above, this step may partially coincide with step 202, as lab request application 14 may access IT resource database 44 during the request process to populate pull-down menus or provide new options in response to user selections. Alternatively, this step may not be performed until after the request is completely received from the user.

Regardless of the order of these steps, IT resource database may contain information regarding resources located at various labs 50. This information may include, but is not limited to technical specifications, times of availability, times of reservation, current status, relationship and compatibility information for each of the IT resources, and information regarding pools in which the resources reside. This information is stored in IT resource database 44, but may be based on the actual resources stored in the various labs 50. According to particular embodiments, lab request application 14 may regularly contact the various labs, using communications network 20, to determine what resources are available, when they are available, and which pools, if any, they reside in. If anything has changed, IT resource database 44 may have its information updated accordingly. According to particular embodiments, each of the labs 50 may automatically notify IT resource database 44 if any IT resources are added or deleted from the lab, if any of their reservation statuses change, or if pool membership changes.

At step 206, lab request application 14 determines one or more pools that the user has access to. As described above, this step may partially coincide with steps 202 and 204. According to particular embodiments, this information may be stored in IT resource database 44. In alternative embodiments, the information may be stored in lab request application 14 or otherwise tied to a particular user. Either way, this information may define relationships between a particular user and a plurality of pools.

For instance, the user may be an owner of pools 52, 54, and 56. According to particular embodiments, this means that the user has access to all of the IT resources located in pools 52, 54, and 56. In more particular embodiments, the user may have priority access to those resources over any other users. In particular embodiments, the user may also grant access for other users to pools 52, 54, and 56. Additionally, the user may be able to define or modify a policy set for the pools.

Additionally, the user may not own any other pools, but may be granted access to pools 58, 60, and 62 by the respective owners of those pools. According to particular embodiments, this means the user may have access to the IT resources on pools 58, 60, and 62. However, this access may be subject to the policy sets defined by the owners of those pools. Additionally, the owners may receive prioritized access to the resources over the user.

Finally, the user may not have any specific access to pools 64, 66, and 68. According to particular embodiments, if these are private pools with their own owners, this may mean that the user simply has no access to any of the resources stored in the pools. However, if the pools have been designated public, the user, along with any other user, may have access to all of the IT resources located therein.

At step 208, after the user's reservation request is completely submitted, the lab request application 14 checks the applicable resource pools to determine if they contain resources that match the requested technical specification. The technical specification may be any technical requirements that are included in the user's desired configuration. For instance, this may be as simple as the type of operating system requested, as well as the name of any additional hardware requested. According to particular embodiments, much more detailed technical specifications may be included in the desired configuration requested by the user. For instance, the user may begin by selecting the general type of operating system and then select a specific version of that operating system. Next, the user may select the machine or hardware on which the operating system should run. This may be any type of proprietary or non-proprietary hardware. Finally, the user may select specific software to run on the machine. This software may include various databases, testing tools, utilities, or any other approved third party software. According to particular embodiments, the lab request application 14 may search the applicable resource pools in a particular order. For instance, in particular embodiments, the user may own pools 52, 54, and 56, have access to private pools 58, 60, and 62, and have general access to public pools 64, 66, and 68. According to these embodiments, lab request application 14 would begin by searching pools 52, 54, and 56, then move on to pools 58, 60, and 62, and finally search pools 64, 66, and 68. In alternative embodiments, various searching priorities may be employed to provide efficient operation.

According to particular embodiments, if there is no exact match of the requested technical specifications, an alternative configuration may be suggested to the user at step 210. For instance, a user may request a particular operating system and several additional pieces of hardware. After searching the relevant resource pools at step 208, it may be determined that the operating system is available, but not all of the requested pieces of hardware are available. According to particular embodiments, the system may provide the user with a “closest match” of resources that most closely match the exact desired configuration. According to alternative embodiments, the user may be given more than one “close match” and left to decide if any are preferable. This step may be performed automatically, or in alternative embodiments, the lack of a match may trigger manual intervention and suggestion of one or more alternative configurations. If, after being presented with one or more alternative technical configurations, the user turns down the alternative options, the process ends and no IT resources are reserved for the user.

However, if one or more resources matching the desired technical specifications are found, or if the user accepts a suggested alternative technical configuration, the process continues to step 214 where the desired reservation time is checked for a match. At this step, lab request application 14 checks the relevant resource pools to determine if the matching resources are available at the desired reservation time.

If the matching resources are not available at the desired reservation time, at step 216 an alternative reservation time may be suggested. According to particular embodiments, this may comprise presenting to the user one or more reservation time frames that match the start and stop times requested by the user. Alternatively, the user may be presented with a list of all of the times the matching resources are available and allowed to select a reservation time span from within this list.

An alternative reservation time may even be suggested if the matching resources are available during part, but not all of the desired reservation time. In these situations, alternative reservation times may be suggested as described above. According to alternative embodiments, a shorter duration reservation time may also be suggested to the user.

Any of the suggestions described above may be presented to the user through the user interface of computer terminal 12. For instance, these notifications may be displayed within the user interface or come in the form of pop-up windows or similar messages. According to alternative embodiments, the user may receive an e-mail message stating that the requested IT resources are not available at the requested time and presenting one or more alternative reservation times. If, after being presented with one or more alternative reservation times, the user turns down the alternative options, the process ends and no IT resources are reserved for the user.

If, however, the matching resources are available at the desired reservation time, or if the user accepts one of the alternative reservation times, the method proceeds to step 220, where the IT resources are reserved according to the user's wishes. At this point, lab request application 14 contacts the relevant labs 50 containing the matching resources. These resources are marked in the relevant labs as reserved for the length of the reservation time. This information is also updated within IT resource database 44 to reflect that the matching resources are reserved for a certain user at the specified reservation time. Therefore, if a different user tried to reserve the same IT resources at the same reservation time, the IT resource database 44 would show these resources as reserved, and the user would be prompted with an alternative technical configuration and/or an alternative reservation time.

At step 222, after IT resources are reserved for a user, the resources are provided to the user at the start of the reserved time. This may also be referred to as the start of the lease. According to particular embodiments, this may involve the resources being automatically downloaded and installed on a lab computer and provisioned for use by the user. In these embodiments, the user may be notified via email, pop-up window, or similar notification after the resources have been downloaded. According to alternative embodiments, lab request application 14 may notify the user that the reservation time has begun, but may require user acknowledgement before the IT resources are actually provisioned.

After the downloading, installation, and provisioning, the user is able to manage the IT resources throughout the duration of the lease. According to particular embodiments, the user may also request automated re-installations or re-imaging of operating systems or third party applications during the reservation time. For instance, this may be useful during the quality assurance portion of software development. If a new build is begun, it may be desirable for the user to start over with a clean copy of the reserved operating system. As long as the operating system is currently leased to that user, it may be re-installed.

During the length of the lease, lab reservation application 14 may also monitor use of the reserved resources by the user. If particular resources are not being used, the provisioned machine may automatically power off. This may provide more efficient energy management, as machines often remain powered on at all times in a normal lab environment, even when particular resources are not currently in use. This energy management and powering down may also apply where virtual resources are being used, such that less power is used by the main server. Additionally, at the end of the lease, the provisioned machine may automatically power off before the IT resources are returned to their labs. This may also provide efficient energy management.

At the end of the lease, the IT resources may be returned to their labs and made available to other users. In particular embodiments, the user may be notified shortly before this time occurs and given the option to extend the lease or re-reserve the IT resources. According to alternative embodiments, this option may not be presented, and the resources may simply be returned at the end of the lease. This may be particularly true if another user has already reserved one or more of the IT resources for a time beginning immediately after the end of the first user's lease. The extension of a lease may be an automated process, but may also be subject to limitations defined by the administrator. For instance, a user may be able to extend a lease for a short amount of time, but may not be able to extend it for a very long duration. In still other embodiments, the user may have the option to return IT resources early if they are no longer wanted or needed. In this case, the user may return the IT resources to their respective labs 50, and IT resource management database 44 is updated to reflect that the resources are no longer reserved. According to particular embodiments, the end of the lease may also result in a power off in order to increase energy management.

Additionally, during the length of the lease, an administrator or owner of the lab resources may also manage the leased IT resources. Similar to the user, the administrator can extend or renew the lease. Additionally, the administrator may be able to cancel a lease, returning the IT resources before the reserved end of lease time. The administrator may also move leases between multiple machines to allow for more efficient resource management. According to particular embodiments, the user may be notified whenever the administrator takes some action that affects the leased resources.

It should be understood that some of the steps illustrated in FIG. 2 may be combined, modified, or deleted where appropriate, and additional steps may also be added to the flow diagram.

In addition to the advantages enumerated above, various embodiments of the present disclosure provide other benefits. In general, the method of the present disclosure may allow for more efficient resource allocation. Specifically, in the software development process, development teams often experience “peaks” in which there is a very high demand for access to IT resources, and “valleys” in which there is very low demand. The provisioning of resources between multiple development teams may allow one team to access resources during a peak while other teams are in a valley, providing more efficient utilization of resources.

In particular embodiments, the method of the present disclosure may allow for sharing of expensive IT resources between various groups, with little or no manual intervention. Additionally, the method may provide power management and energy conservation, such that only active servers remain powered on. The method may also provide a user the ability to view labs organized in any particular desired manner. Various other advantages may be readily apparent to one having skill in the art.

Although the present invention has been described in detail, it should be understood that various changes, substitutions, and alterations can be made without departing from the spirit and scope of the invention as defined by the appended claims.

What is claimed is:

1. A method, comprising:
receiving, from a user, a request to reserve a desired configuration of IT resources, wherein the desired configuration comprises:
one or more desired technical specifications; and
a desired reservation time having a start time and an end time;
accessing an IT resource database to determine one or more of a plurality of resource pools that the user has access to;
consulting the one or more resource pools to determine if one or more IT resources matching the desired configuration are available;
if the one or more IT resources matching the desired configuration are available, reserving the one or more IT resources for the user; and
providing the desired configuration of IT resources to the user at the start time.

2. The method of claim 1, further comprising:
if the one or more IT resources are not available at the desired reservation time, suggesting an alternative time to the user for reservation; and
if the user accepts the alternative time:
reserving the one or more IT resources at the alternative time; and
providing the desired configuration of IT resources to the user at the alternative time.

3. The method of claim 1, further comprising:
if the one or more IT resources do not match the one or more technical specifications, suggesting an alternative configuration of IT resources to the user for reservation; and
if the user accepts the alternative configuration of IT resources:
reserving the alternative configuration of IT resources; and
providing the alternative configuration of IT resources to the user at the start time.

4. The method of claim 1, wherein each of the plurality of resource pools comprise a respective policy set refinancing:
who may reserve IT resources stored in the resource pool; and
the maximum length of time for which IT resources stored in the resource pool may be reserved.

5. The method of claim 6, wherein each of the plurality of resource pools is managed by an owner, and wherein the owner may manage the policy set for a respective resource pool.

6. The method of claim 1, further comprising storing the desired configuration of the user in the IT resource database as a favorite configuration for later retrieval and re-use.

7. The method of claim 1, wherein the request to reserve a desired configuration of IT resources comprises a Web Services format.

8. A system, comprising:
a graphical user interface being operable to receive, from a user, a request to reserve a desired configuration of IT resources, wherein the desired configuration comprises:
one or more desired technical specifications; and
a desired reservation time having a start time and an end time;
an IT resource database being operable to store IT resources;
a processor operable to:
access the IT resource database;
determine one or more of a plurality of resource pools that the user has access to;
consult the one or more resource pools to determine if one or more IT resources matching the desired configuration are available;
if the one or more IT resources matching the desired configuration are available, reserve the one or more IT resources for the user; and
provide the desired configuration of IT resources to the user at the start time.

9. The system of claim 8, wherein if the one or more IT resources are not available at the desired reservation time, the processor is further operable to:
suggest an alternative time to the user for reservation; and
if the user accepts the alternative time:
reserve the one or more IT resources at the alternative time; and
provide the desired configuration of IT resources to the user at the alternative time.

10. The system of claim 8, wherein if the one or more IT resources do not match the one or more technical specifications, the processor is further operable to:
suggest an alternative configuration of IT resources to the user for reservation; and
if the user accepts the alternative configuration of IT resources:
reserve the alternative configuration of IT resources; and
provide the alternative configuration of IT resources to the user at the start time.

11. The system of claim 8, wherein each of the plurality of resource pools comprise a respective policy set defining:
who may reserve IT resources stored in the resource pool; and
the maximum length of time for which IT resources stored in the resource pool may be reserved.

12. The system of claim 11, wherein each of the plurality of resource pools is managed by an owner, and wherein the owner may manage the policy set for a respective resource pool.

13. The system of claim 8, wherein the IT resource database is further operable to store the desired configuration of the user as a favorite configuration for later retrieval and re-use.

14. The system of claim 8, wherein the request to reserve a desired configuration of IT resources comprises a Web Services format.

15. Logic encoded in a tangible computer readable medium and being operable, when executed on a processor, to:
receive, from a user, a request to reserve a desired configuration of IT resources, wherein the desired configuration comprises:
one or more desired technical specifications; and
a desired reservation time having a start time and an end time;
access an IT resource database to determine one or more of a plurality of resource pools that the user has access to;
consult the one or more resource pools to determine if one or more IT resources matching the desired configuration are available;
if the one or more IT resources matching the desired configuration are available, reserve the one or more IT resources for the user; and
provide the desired configuration of IT resources to the user at the start time.

16. The logic of claim 15, wherein, if the one or more IT resources are not available at the desired reservation time, the logic is further operable to:
suggest an alternative time to the user for reservation; and
if the user accepts the alternative time:
reserve the one or more IT resources at the alternative time; and
provide the desired configuration of IT resources to the user at the alternative time.

17. The logic of claim 15, wherein, if the one or more IT resources do not match the one or more technical specifications, the logic is further operable to:
suggest an alternative configuration of IT resources to the user for reservation; and
if the user accepts the alternative configuration of IT resources:
reserve the alternative configuration of IT resources; and
provide the alternative configuration of IT resources to the user at the start time.

18. The logic of claim 15, wherein each of the plurality of resource pools comprise a respective policy set defining:
who may reserve IT resources stored in the resource pool; and
the maximum length of time for which IT resources stored in the resource pool may be reserved.

19. The logic of claim 18, wherein each of the plurality of resource pools is managed by an owner, and wherein the owner may manage the policy set for a respective resource pool.

20. The logic of claim 15, wherein the IT resource database is further operable to store the desired configuration of the user as a favorite configuration for later retrieval and re-use.

21. The logic of claim 15, wherein the request to reserve a desired configuration of IT resources comprises a Web Services format.
